(19) United States
(12) Patent Application Publication
(10) Pub. No.: US 2014/0358538 A1
(43) Pub. Date: Dec. 4, 2014

(54) METHODS AND SYSTEMS FOR SHAPING DIALOG OF SPEECH SYSTEMS

(71) Applicant: GM GLOBAL TECHNOLOGY OPERATIONS LLC, Detroit, MI (US)

(72) Inventors: Ron M. Hecht, Ra'anana (IL); Eli Tzirkel-Hancock, Ra'anana (IL); Omer Tsimhoni, Ramat Hasharon (IL); Ute Winter, Petach Tiqwa (IL)

(73) Assignee: GM GLOBAL TECHNOLOGY OPERATIONS LLC, Detroit, MI (US)

(21) Appl. No.: 13/903,626

(22) Filed: May 28, 2013

(51) Int. Cl. G10L 15/07

(52) U.S. Cl. CPC G10L 15/07
USPC 704/243

(57) ABSTRACT

Methods and systems are provided for shaping speech dialog of a speech system. In one embodiment, a method includes: receiving data related to a first utterance from a user of the speech system; processing the data based on at least one attribute processing technique that determines at least one attribute of the first utterance; determining a shaping pattern based on the at least one attribute; and generating a speech prompt based on the shaping pattern.

### TECHNICAL FIELD

The technical field generally relates to speech systems, and more particularly relates to methods and systems for shaping dialog within a speech system.

### BACKGROUND

Vehicle speech recognition systems perform speech recognition or understanding of speech uttered by occupants of the vehicle. The speech utterances typically include commands that communicate with or control one or more features of the vehicle or other systems that are accessible by the vehicle. Speech recognition performance may vary depending on attributes of the user's speech such as, rhythm, vocabulary, verbosity, dialect, accent, etc.

A speech dialog system generates speech prompts in response to the speech utterances. In some instances, the speech prompts are generated in response to the speech recognition system needing further information in order to perform the speech recognition. For example, a speech prompt may ask the user to repeat the speech utterance or may ask the user to select from a list of possibilities. In some instances, such speech prompts may result in the receipt of a speech utterance that fails to resolve the recognition issue.

Accordingly, it is desirable to provide improved methods and systems for shaping a speech dialog to improve the speech recognition. Accordingly, it is further desirable to provide methods and systems for shaping the speech dialog based on attributes of the user's speech. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for shaping speech dialog of a speech system. In one embodiment, a method includes: receiving data related to a first utterance from a user of the speech system; processing the data based on at least one attribute processing technique that determines at least one attribute of the first utterance; determining a shaping pattern based on the at least one attribute; and generating a speech prompt based on the shaping pattern.

In another embodiment, a speech system includes a first module that receives data related to a first utterance from a user of the speech system. A second module processes the data based on at least one attribute processing technique that determines at least one attribute of the first utterance. A third module determines a shaping pattern based on the at least one attribute. A fourth module generates a speech prompt based on the shaping pattern.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIG. 2 is a dataflow diagram illustrating a speech system in accordance with various exemplary embodiments; and

FIG. 3 is a flowchart illustrating a speech method that may be performed by the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments of the present disclosure a speech system 10 is shown to be included within a vehicle 12. In various exemplary embodiments, the speech system 10 provides speech recognition and a dialog for one or more vehicle systems through a human machine interface module (HMI) module 14. Such vehicle systems may include, for example, but are not limited to, a phone system 16, a navigation system 18, a media system 20, a telematics system 22, a network system 24, or any other vehicle system that may include a speech dependent application. As can be appreciated, one or more embodiments of the speech system 10 can be applicable to other non-vehicle systems having speech dependent applications and thus, is not limited to the present vehicle example.

The speech system 10 communicates with the HMI module and/or the multiple vehicle systems 14-24 through a communication bus and/or other communication means 26 (e.g., wired, short range wireless, or long range wireless). The communication bus can be, for example, but is not limited to, a controller area network (CAN) bus, local interconnect network (LIN) bus, or any other type of bus.

The speech system 10 includes a speech recognition module 32, a dialog manager module 34, and a speech generation module 35. As can be appreciated, the speech recognition module 32, the dialog manager module 34, and the speech generation module 35 may be implemented as separate systems and/or as a combined system as shown. In general, the speech recognition module 32 receives and processes speech utterances from the HMI module 14 using one or more speech recognition techniques (e.g., front end feature extraction may be used that is followed by a Hidden Markov Model (HMM) and scoring mechanism). The speech recognition module 32 generates results of possible recognized speech and an associated confidence score based on the processing.

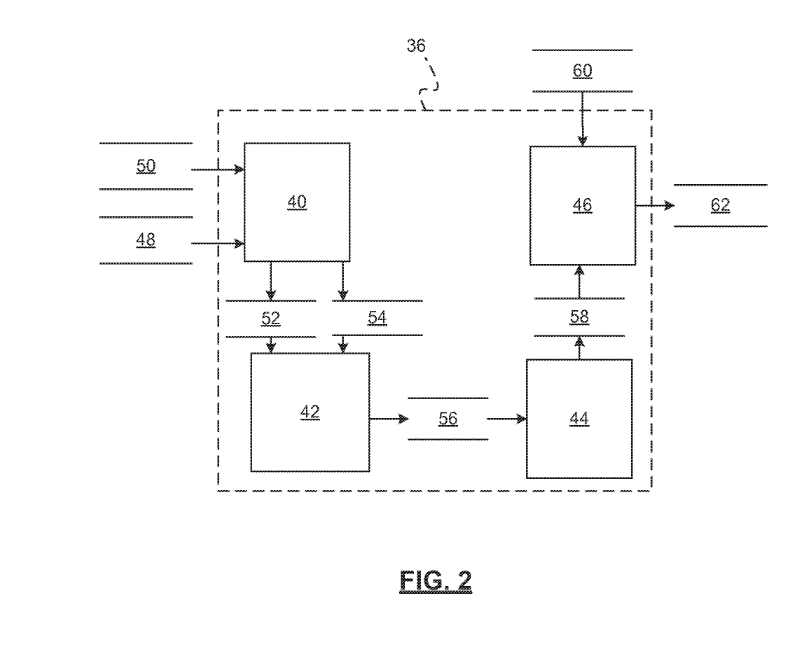

The dialog manager module 34 manages an interaction sequence and a selection of speech prompts to be spoken to the user based on the results of the recognition. In particular, the dialog manager module 34 includes a dialog shaping module 36 (FIG. 2) that detects one or more attributes of the speech utterance and adapts a speech prompt based on the detection. In various embodiments, the attributes include, but are not limited to, a rhythm, a vocabulary, a verbosity, a dialect, and an accent. The speech generation module 35 generates the spoken prompts to the user based on the adapted speech prompt determined by the dialog manager 34. In other words, the speech generation module 35 converts the text of the speech prompt to a spoken prompt that is issued to the user by the HMI module 14.

Referring now to FIG. 2, a dataflow diagram illustrates the dialog shaping module 36 in accordance with various exemplary embodiments. As can be appreciated, various exemplary embodiments of the dialog shaping module 36, according to the present disclosure, may include any number of sub-modules. In various exemplary embodiments, the sub-modules shown in FIG. 2 may be combined and/or further partitioned to similarly shape the dialog based on attributes of a speech utterance. In various exemplary embodiments, the dialog shaping module 36 includes an attribute detection module 40, a learning and adaptation module 42, a pattern module 44, and a dialog manager module 46.

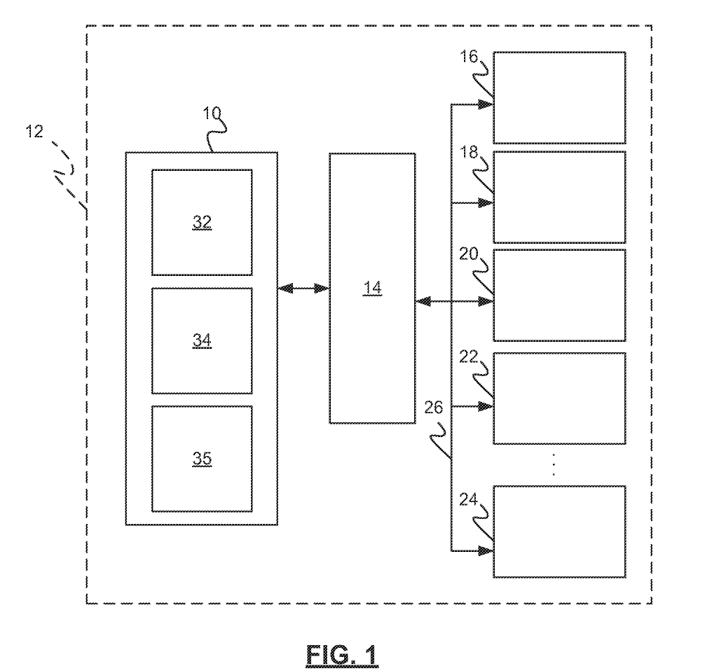

The attribute detection module 40 receives as input data including a speech utterance 48 and results 50 or any other partially processed representation of the utterance from the recognizer module 32 (FIG. 1) (hereinafter generally referred to as a speech utterance 48 and results 50. As discussed above, the recognizer module 32 (FIG. 1) processes a speech utterance (e.g., received from the HMI module 14 (FIG. 1) using one or more speech models to determine the results 50. If the results 50 indicate a low confidence scored (e.g., below a threshold), the attribute detection module 40 processes the speech utterance 48 and/or the results 50 to identify one or more attributes 52 of the speech utterance 48 and/or attribute qualities 54 of the speech utterance 48.

In various embodiments, the attribute detection module 40 identifies the attributes 52 and/or the attribute qualities 54 based on one or more attribute processing techniques. For example, the attribute processing techniques may be based on Hidden Markov Models, or other models known in the art for identifying a particular attribute. In various embodiments, the attribute processing techniques are based on human attributes such as, but not limited to, human speech behaviors, and demographics. Such human attributes may include, but are not limited to, a rhythm of the speech, a vocabulary used in the speech, a verbosity of the speech, a dialect of the speech, and/or an accent of the speech.

In various embodiments, the attribute processing techniques are further based on attribute qualities 54 that are associated with the human attributes. For example, attribute qualities 54 associated with the rhythm of the speech may include, but are not limited, slow, fast, normal, or a specific pace. In another example, attribute qualities 54 associated with the vocabulary of the speech may include, but are not limited, specific vocabulary that is commonly used or recognized and specific vocabulary that is not commonly used or recognized. In other examples, attribute qualities 54 associated with the verbosity of the speech may include, but are not limited, verbose, and non-verbose. In still other examples, attribute qualities 54 associated with the dialect type may include, but are not limited to, specific dialects that are commonly used or easily recognized, and specific dialects that are not commonly used or recognized. Attribute qualities 54 associated with the accent type may include, but are not limited to, specific accents that are commonly used or easily recognized, and specific accents that are not commonly used or recognized.

The learning and adaptation module 42 receives as input the attributes 52 and/or the attribute qualities 54 that were identified by the attribute detection module 40. The learning and adaptation module 42 evaluates the attributes 52 and/or the attribute qualities 54 and selects a cause 56 of the low confidence score associated with the results 50. The cause 56 may be, for example, the verbosity quality indicates verbose, the rhythm quality indicates too fast, etc.

In various embodiments, the learning and adaptation module 42 selects the cause based on a set of rules that associate an attribute 52 and/or attribute quality 54 to a particular cause. In various other embodiments, the learning and adaptation module 42 learns the cause 56 by learning a relationship between the attribute 52 and/or the attribute quality 54 and the cause 56 through iterations of the recognition process. In various embodiments, the learning techniques may select a most probable cause or may explore recognition results in order to find other causes.

As can be appreciated, the learning and adaptation module 42 may identify one or more causes 56. If multiple causes 56 are identified, the multiple causes may be arbitrated based on a priority scheme to identify a most influential cause. Alternatively, the multiple causes may not be arbitrated and the multiple causes are provided for consideration by the pattern module 44.

The pattern module 44 receives as input the identified cause or causes 56. The pattern module 44 determines a shaping pattern 58 based on the identified cause or causes 56. The shaping pattern 58 includes a pattern for modifying or shaping a predefined prompt based on the cause or causes 56. The shaping pattern modifies an attribute and/or an attribute quality of a speech prompt. In various embodiments, a particular shaping pattern 58 may be directly associated with a particular cause. For example, if the identified cause indicates that the rhythm of the speech utterance was too fast, a pattern that lowers the rhythm or pace of the predefined prompt may be selected. In another example, if the identified cause indicates that the speech utterance was too verbose, a pattern that lowers the verbosity of the predefined prompt may be selected. In yet another example, if the identified cause indicates that the speech utterance was due to an uncommonly used dialect or accent, a pattern that modifies an accent of the prompt to be similar to the speaker's accent but more recognizable to the system may be selected.

As can be appreciated, the pattern module 44 may identify one or more shaping patterns 58 based on the one or more causes 56. If multiple shaping patterns are identified, the multiple patterns may be arbitrated based on a priority scheme to identify a best pattern. Alternatively, the multiple patterns may be combined to define a single pattern.

The dialog manager module 46 receives as input the shaping pattern 58 and a predefined speech prompt 60. In various embodiments, the predefined speech prompt 60 may be a prompt that requests further information from the user. The dialog manager module 46 generates a speech prompt 62 based on the shaping pattern 58 and the predefined speech prompt 60. For example, the dialog manager module 46 shapes or modifies the predefined speech prompt 60 by applying the shaping pattern 58 to the predefined speech prompt 60. In various embodiments, the generated speech prompt 62 is in a text format and may be converted to a spoken format and generated to the user, for example, via the HMI module 14 (FIG. 1).

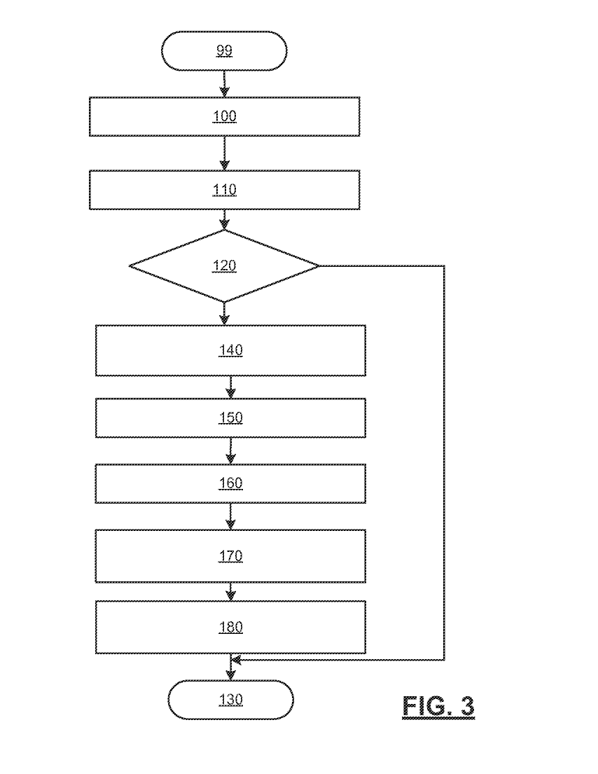

Referring now to FIG. 3 and with continued reference to FIG. 2, a flowchart illustrates a speech method that may be performed by the speech system 10 in accordance with various exemplary embodiments. As can be appreciated in light of the disclosure, the order of operation within the method is not limited to the sequential execution as illustrated in FIG. 3, but may be performed in one or more varying orders as applicable and in accordance with the present disclosure. As can further be appreciated, one or more steps of the method may be added or removed without altering the spirit of the method.

As shown, the method may begin at 99. The speech utterance 48 is received at 100. One or more speech recognition methods are performed on the speech utterance 48 to determine the results 50 at 110. The results 50 are evaluated at 120. If a confidence score associated with the results 50 is high (e.g., above a threshold), then the method may end at 130.

If, however, the confidence score associated with the results 50 is low (e.g., below a threshold) at 120, then the speech utterance 48 and/or the results 50 is further processed based on one or more attribute processing techniques to identify one or more attributes 52 and/or attribute qualities 54 at 140. One or more causes 56 of the low confidence score is determined at 150 based on the one or more attributes 52 and/or one or more attribute qualities 54. A shaping pattern 58 is determined based on the one or more causes 56 at 160. The shaping pattern 58 is then used to shape or modify a speech prompt 60 at 170. Thereafter, the shaped or modified speech prompt 62 is generated as a spoken command to the user at 180 and the method may end at 130.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method of shaping a speech dialog of a speech system, comprising:
receiving data related to a first utterance from a user of the speech system;
processing the data based on at least one attribute processing technique that determines at least one attribute of the first utterance;
determining a shaping pattern based on the at least one attribute; and
generating a speech prompt based on the shaping pattern.

2. The method of claim 1, further comprising:
processing the data based on one or more speech recognition methods;
determining a confidence score based on the speech recognition methods, and
wherein the processing the data based on the least one attribute processing technique is selectively performed based on the confidence score.

3. The method of claim 1, wherein the at least one attribute processing technique is based on at least one of a rhythm of speech, a vocabulary of speech, a verbosity of speech, an accent of speech, and a dialect of speech.

4. The method of claim 1, wherein the processing the data is based on at least one attribute processing technique that determines at least one attribute quality of the first speech utterance, and wherein the determining the shaping pattern is based on the at least one attribute quality.

5. The method of claim 1, wherein the at least one attribute quality is based on a quality of at least one of a rhythm of speech, a vocabulary of speech, a verbosity of speech, an accent of speech, and a dialect of speech.

6. The method of claim 1, wherein the shaping pattern modifies an attribute of a speech prompt.

7. The method of claim 1, wherein the shaping pattern modifies at least one of a rhythm of speech, a vocabulary of speech, a verbosity of speech, an accent of speech, and a dialect of speech.

8. The method of claim 6, wherein the shaping pattern modifies a quality of an attribute of a speech prompt.

9. The method of claim 8, wherein the shaping pattern modifies the quality of the attribute of the speech prompt based on a determined cause of a recognition confidence score being below a threshold.

10. The method of claim 1, wherein the generating the speech prompt comprises applying the shaping pattern to a predefined speech prompt, and generating the speech prompt based on the predefined speech prompt that has been shaped.

11. A speech system for shaping speech dialog, comprising:
a first module that receives data related to a first utterance from a user of the speech system;
a second module that processes the data based on at least one attribute processing technique that determines at least one attribute of the first utterance;
a third module that determines a shaping pattern based on the at least one attribute; and
a fourth module that generates a speech prompt based on the shaping pattern.

12. The speech system of claim 11, wherein the first module processes the data based on one or more speech recognition methods, and determines a confidence score based on the speech recognition methods, and wherein the second module selectively processes the data based on the confidence score.

13. The speech system of claim 11, wherein the at least one attribute processing technique is based on at least one of a rhythm of speech, a vocabulary of speech, a verbosity of speech, an accent of speech, and a dialect of speech.

14. The speech system of claim 11, wherein the second module processes the data based on at least one attribute processing technique that determines at least one attribute quality of the first utterance, and wherein the third module determines the shaping pattern based on the at least one attribute quality.

15. The speech system of claim 11, wherein the at least one attribute quality is based on a quality of at least one of a rhythm of speech, a vocabulary of speech, a verbosity of speech, an accent of speech, and a dialect of speech.

16. The speech system of claim 11, wherein the shaping pattern modifies an attribute of a speech prompt.

17. The speech system of claim 11, wherein the shaping pattern modifies at least one of a rhythm of speech, a vocabulary of speech, a verbosity of speech, an accent of speech, and a dialect of speech.

18. The speech system of claim 16, wherein the shaping pattern modifies a quality of an attribute of a speech prompt.

19. The speech system of claim 18, wherein the shaping pattern modifies the quality of the attribute of the speech prompt based on a determined cause of a recognition confidence score being below a threshold.

20. The speech system of claim 11, wherein the fourth module generates the speech prompt by applying the shaping pattern to a predefined speech prompt, and generating the speech prompt based on the predefined speech prompt that has been shaped.
